(19) United States
(12) Patent Application Publication
(10) Pub. No.: US 2003/0067990 A1
(43) Pub. Date: Apr. 10, 2003

(54) Peak to average power ratio reduction in a digitally-modulated signal

(76) Inventor: Paul Henry Bryant, Encinitas, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/968,469

(22) Filed: Oct. 1, 2001

(51) Int. Cl. H04L 27/00; H04B 15/00; H04K 1/02

(52) U.S. Cl. 375/259; 375/285; 375/350

(57) ABSTRACT

In a digital communication system, the peak-to-average power ratio (PAR) is reduced by means of a compressor characterized by a nonlinear function that operates on a digitally-modulated signal prior to its conversion to analog form. The compressed, converted signal is transmitted through a dispersive channel, received, and converted back into digital form. The received signal is decompressed by a nonlinear equalizing element characterized by decompression function. The decompression function may be a one-dimensional power series with settable parameters, it may be the inverse of the compression function; and it may be a generalized expansion other than a power series. Decompression may be preceded by correction of the received signal for the effects of linear distortion.

### CROSS REFERENCE TO RELATED APPLICATION

This application is related to U.S. application Ser. No. ______, entitled, A MULTISTAGE EQUALIZER THAT CORRECTS FOR LINEAR AND NONLINEAR DISTORTION IN A DIGITALLY-MODULATED SIGNAL, which is commonly owned and concurrently filed herewith, and which is incorporated herein by this reference.

### BACKGROUND OF THE INVENTION

The invention concerns the transmission of information by digitally-modulated means in which the peak to average power ratio (PAR) of a digitally-modulated signal is reduced by compression of the digital representation of the signal prior to transmission. More particularly, the compression is obtained by subjecting the digital representation to a compressing, nonlinear function preceding conversion of the signal to analog form for transmission in a dispersive channel.

Digital modulation refers to the use of digital codes to vary one or more characteristics of one or more carriers in a way that plants information into the variation. In this regard, a modulated carrier “carries” the information. An unmodulated carrier may have zero frequency, that is, it may have a constant level such as voltage, or it may be time-varying, like a sine wave. The variation produced by digital modulation may be in one or more of the amplitude, phase, and frequency of a carrier. The purpose of digital modulation is to have information transmitted via the modulated signal or signals in, for example, a communication channel or a data storage channel.

A signal may exist in analog form or in digital form. In analog form, the signal consists of a continuous, time-varying amplitude in the form of a voltage or a current. In digital form, the signal consists of a sequence of real numbers, often called a time series. Each real number has a digital form, in the numeric sense and in the waveform sense. This sequence of real numbers can be interpreted as a sequence of measured amplitudes of the analog signal. It should be noted that the concept of a signal carrying digital information is distinct from whether that signal is represented in digital or analog form.

For clarity, “transmission” of digitally modulated signals refers to their passage through a signal path that includes a channel plus any other elements at either end of the channel through which the signals must pass in order to be placed in or received from the channel. The term “channel” means a physical medium used to conduct or store signals. Examples of channels include twisted pairs of wires, coaxial cables, optical fibers, electromagnetic waves in space, magnetic recording media, optical recording media, and so on. In addition to a channel, a signal path includes components or elements that are coupled to either end of a channel in order to feed digitally-modulated signals into the channel or to receive them from the channel.

A single channel may provide oppositely-directed transmission for two signal paths. Two-way transmission through a single, shared channel requires means in the channel for separating outgoing from incoming signals at each end of the channel; it may also require repeater means in the channel capable of separating and then recombining oppositely-directed signals intermediate the ends of the channel.

Transmission of digitally-modulated signals in a system designed for digital communication or data storage often assails those signals with linear distortion and nonlinear distortion. Such distortion degrades the signals and requires corrective measures when the signals are received in order that information can be reliably extracted from the signals.

Linear distortion changes the shapes of signals as they are transmitted. In this regard, a channel through which the signals are transmitted disperses the amplitudes and phases of the components of the signals to unequal degrees that are dependent upon the frequencies of the components. The result is smearing in the received signals, which can lead to intersymbol interference. Such a channel is denominated a “dispersive channel”. A channel in which the output changes in direct proportion to changes made in the input signal or some component thereof may be considered a “linear channel”. However in such a channel the components of different frequencies may travel through the channel at different speeds and be attenuated by different factors. These effects of linear distortion can be ameliorated by equalization of received signals. A linear equalizer removes or reduces the effects of linear distortion by making adjustments in the components of a received signal to compensate for the changes made in those components by transmission through the channel.

Nonlinear distortion occurs when the proportionality or linearity with which a signal is being distorted is violated to some degree. Typically such nonlinear effects are not distributed throughout the signal path, but rather are concentrated at particular sites. Some examples of nonlinear distortion include: (1) a driver at the input to a channel or a mid-channel repeater that exhibits some nonlinearity dependant on the signal amplitude or on the derivative of the amplitude (slew rate); (2) a corroded contact in a channel that has some nonlinear (non-ohmic) characteristics; (3) a transformer in a channel that exhibits some significant nonlinearity, perhaps related to magnetic hysteresis in its core. Further, a nonlinear distortion of known characteristics of a digitally-modulated signal could be introduced intentionally in order to improve some performance factor of a communications or data storage process (with the expectation, of course, that the effects of this distortion can later be successfully removed).

Nonlinear distortion is particularly harmful to digitally modulated signals having M possible waveforms. Since either or both phase and amplitude of a signal are modulated in an M-ary modulation scheme, it is important that the modulation be preserved when the signal is amplified for transmission. In some multiple-carrier schemes, such as Discrete Multitone (DMT) modulation, in-phase occurrence of multiple carriers can cause high peak values, while the root mean square (RMS) value remains low. In central offices providing digital subscriber loop (DSL) service via DMT modulation, this results in a requirement for very linear power amplifiers with high PAR. The need to produce the highest peaks results in undesirably high power consumption. This is especially true at central office locations where a large number of transmitters must operate in close proximity, frequently resulting in the need for costly thermal mitigation technology.

PAR limitation in DMT modulated systems has been analyzed by Tellado and Cioffi (“Multicarrier Modulation with Low PAR: Applications to DSL and Wireless”, 2000: Kluwer Academic Publishers). The authors allow nonlinear distortion of the amplified digitally-modulated signal by clipping or saturation of the power amplifier (or saturation of a digital-to-analog converter preceding the amplifier), followed by recovery from the nonlinear effects by use of a maximum likelihood (ML) receiver characterized by an iterative ML algorithm that is intended to converge on real time signal data. Other PAR reduction schemes are set forth in U.S. Pat. No. 6,140,141, and in the following PCT Applications: WO93/09619; WO00/71543; and WO99/55025.

The disclosed PAR limitation schemes all omit consideration of intentionally distorting the numerical representation of a signal with a nonlinear or piecewise linear function that limits PAR in the signal itself, followed by intentional, active reversal of the distortion in the received signal, without depending on real-time signal data for convergence of an iterative ML process.

### SUMMARY OF THE INVENTION

The invention provides an effective solution to the problem of limiting PAR in digitally-modulated signals transmitted in the dispersive signal path of a digital communication system. The solution is practiced by compressing digital values representing the signal amplitudes by means of a compressor characterized by a known nonlinear function (“the compression function”) prior to conversion to analog form and transmission. The now-compressed analog signals are transmitted and received. The received (and compressed) analog signals are then converted back to digital form. Decompression is then performed on the digital values representing the compressed amplitude values by a function that reverses the effect of the compression function; this function is referred to as “the decompression function”.

### BRIEF DESCRIPTION OF THE DRAWINGS

FIG. 1 is a block diagram of elements of a digital communication system according to the invention that limits PAR by intentionally distorting a digitally-modulated signal in a compressor characterized by a known nonlinear function. The system provides for equalization and decompression of the signal, following transmission.

FIG. 2 is a graph showing a compression function embodied in an inverse linear plus cubic form.

FIG. 3 illustrates an embodiment of a linear stage of a multistage equalizer that may be used to process a received PAR-limited signal according to the invention.

FIGS. 4a, 4b and 4c illustrate embodiments of a non-linear stage of the multistage equalizer that may be used to reverse the compression of the PAR-limited signal.

FIG. 5 is a graph illustrating the effects of PAR reduction according to the invention.

### DETAILED DESCRIPTION OF THE PREFERRED EMBODIMENTS

In this detailed description, PAR limitation is achieved in a digital communication system in which information is carried on digitally-modulated signals that are transmitted or propagated in a signal path that includes a channel. The channel may be embodied in any one of a plurality of media. The channel is linearly dispersive, and may be referred to as “linear” or as “dispersive”. Prior to transmission through the channel, the signals, in digital form, are processed in a compressor characterized by a known nonlinear function, referred to hereinafter as “the compression function”. As a result, the PAR of the signals is limited. However, linear distortion that the channel and other components of the signal path impose acts upon and compounds the nonlinear distortion imposed by the compression function, making signal correction that much more difficult.

The invention is illustrated in one or more of the above-described drawings, and is disclosed in detail in the following description. Although these illustrations and the description may show and describe elements that are “connected”, this is done in order to establish a sequence with respect to those elements, and to set up a basis for discussion of how those elements act cooperatively. Accordingly, it is within the scope of the invention to place other elements not illustrated or described herein in the connections between elements that are illustrated and described.

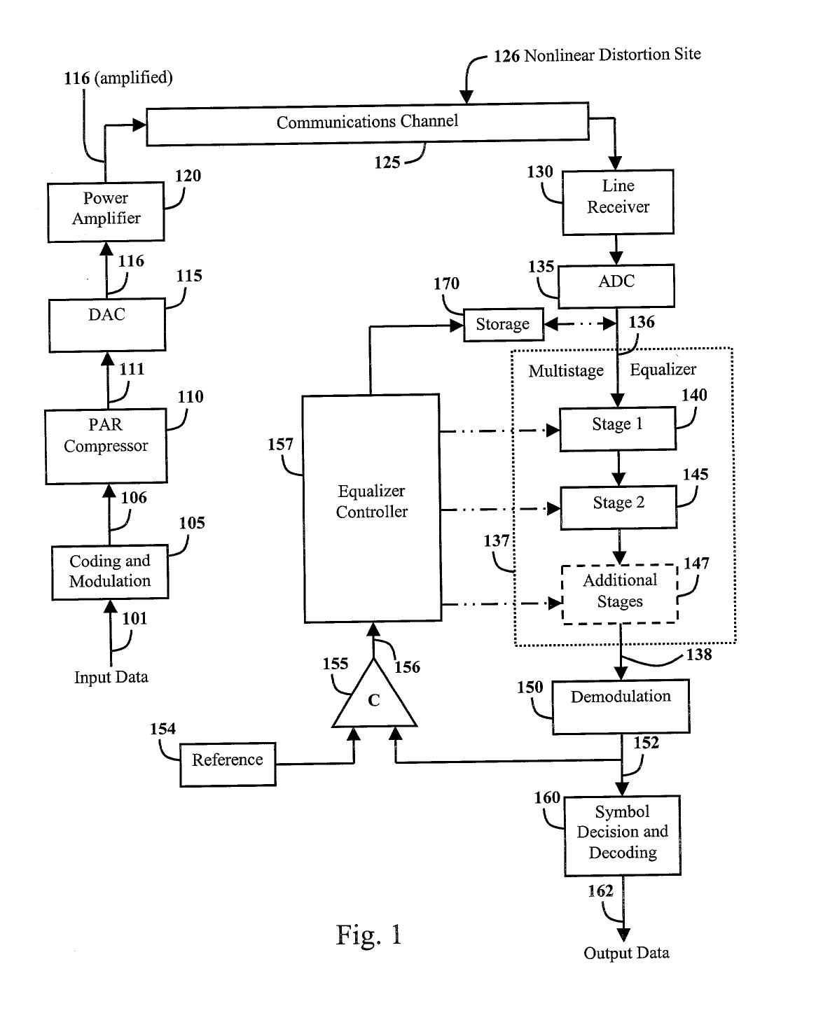

Refer to FIG. 1, which is a block diagram of a digital communication system wherein input data 101 to be transmitted to a destination is provided to coding and modulation circuitry 105. (Note that the processing of digital information can be done either in hardware or software—this applies to all parts of FIG. 1, except those with reference numbers from 115 through 135 where the signal is in analog form.) The circuitry 105 maps the input data 101 to a digital code. This coded data is broken down into a sequence of symbols. Each symbol represents a certain number of bits of digital data. These symbols are then used to modulate a carrier or set of carriers in one or more of amplitude, frequency, and phase. For every allowed symbol there will be a unique setting for these carrier parameters which will remain fixed for a certain length of time before switching to those representing the next symbol. Digital modulation signals 106 are produced by the circuitry 105. These signals 106 represent, in digital form, the amplitudes of digitally-modulated signals that are to be transmitted. The signals 106 are provided as a sequence of digital values to a PAR compressor 110 that operates according to the invention to compress the signal amplitudes. The product of the compressor is a sequence of digital values 111 representing the amplitudes of digitally-modulated signals following compression. This sequence of digital values 111 is input to a digital-to-analog converter (DAC) 115. The DAC 115 converts the sequence of digital values to analog form 116. The signals 116 are coupled from the DAC 115 to the input of a power amplifier 120. The power amplifier 120 drives the medium in which a channel 125 is embodied. Typically the power amplifier 120 is part of a hybrid circuit (“hybrid”)—the term commonly used for a device that allows simultaneous transmission and reception of data on a single channel. The medium is dispersive, and linearly distorts the signals as they propagate through it. The propagated signals are coupled from the channel 125 to a line receiver 130 (also typically part of a hybrid circuit). The line receiver 130 is coupled to an analog-to-digital converter (ADC) 135 that converts the incoming data from analog form to digital form. These signals (referred to as “received digital modulation signals”) 136 are then processed in order to remove the nonlinear effect produced by the compressor, thereby to decompress the signal.

The reversal of compression may be performed, for example, in a multistage equalizer 137 that is constituted of a sequence of linear and nonlinear stages. For application according to this invention, the multistage equalizer has at least two stages 140 and 145; it includes additional stages 147 when necessary. Each of the stages is characterized by a respective function that may contain adjustable parameters. These adjustable parameters allow the performance of the stage to be optimized for particular channel characteristics. Details of these stages are disclosed later.

Following correction by the multistage equalizer 137, the corrected digital modulation signals 138 are provided to demodulation circuitry 150, which extracts the carrier modulation parameters 152. The carrier modulation parameters 152 are provided to symbol decision and decoding circuitry 160. The symbol decision and decoding circuitry 160 compares the carrier modulation parameters to those corresponding to the allowed symbol set, and selects the symbol that most closely matches. The symbol is converted back into digital data and decoded to produce the output data 162.

In order to optimize the performance of the multistage equalizer 137, a known sequence of symbols may be sent through the channel 125. The extracted sequence of carrier modulation parameters 152 for this known sequence is connected to a comparator 155. The comparator 155 compares the received values to reference values 154 corresponding to the known sequence and produces an error measure 156 having a value based upon how well the received modulation parameters 152 compare with these reference values. The error measure 156 is coupled to an equalizer controller 157. The equalizer controller 157, in response to the value of the error measure 156, sets and changes values of parameters, and provides the values to the stages of the multistage equalizer 137. These parameters are components of functions that characterize one or more of the stages of the multistage equalizer 137. The equalizer controller 157 employs or executes a procedure for setting these parameters. The procedure may be embodied for example in an iterative optimization process in which a data set collected at the output of the ADC 135 (and stored at a location 170) is processed through the multistage equalizer 137 a number of times as the parameters values are optimized. The data set may be transmitted once through the signal path 110, 115, 116, 120, 125, 130, captured at the output of the ADC 135 and stored at 170. Function parameter optimization is described in detail in the incorporated patent application.

There are many sources in the system of FIG. 1 that impose distortion on signals transmitted through the channel 125. Linear distortion typically results from transmission through the medium of which the channel 125 is constituted. Linear distortion may also result from other components in the signal path. Nonlinear distortion may be imposed by, for example, a source 126 in the channel 125. Nonlinear distortion may also result from processing by elements 115, 120, 130, and 135. And, of course, nonlinear distortion is intentionally imposed by the compressor 110.

The PAR (peak to average power ratio) of a signal to be transmitted through the signal path is reduced by the compressor 110. The compressor 110 is characterized by a nonlinear function that partially suppresses higher amplitude portions of the signal relative to lower amplitude ones. After passing through the channel 125, the received signal is processed to remove the effects of compression using the multistage equalizer 137. Although the multistage equalizer 137 may have multiple stages, two stages may be employed in connection with this invention: the linear stage 140 to remove the effects of linear dispersion and the nonlinear stage 145 that reverses the compression and that may also help reduce the effects of other distortions, such as may be produced by nonlinearities in the channel 125 and by line drivers and digital to analog converters in the transmitter. As a result of reduced PAR, significant savings in power consumption may be achieved, which is of critical importance at central office locations. Also the analog-to-digital and digital-to-analog converters used for conversion of digitally-modulated signals will have improved resolution and linearity due to the reduced ratio between the highest peaks and the average signal level.

The incorporated U.S. patent application describes a multistage equalizer that is able to remove from a received signal the effects of linear distortion occurring in the signal path, as well as nonlinear distortions occurring at one or more discrete locations (such as 126) in the signal path. In the invention described herein, PAR (peak-to-amplitude ratio) is reduced by intentionally introducing a distortion to compress the signal at the transmitter and then decompressing the signal in the receiver to remove the distortion and recover the data. An optional benefit of this methodology is the possibility of simultaneously reducing any other nonlinear distortion generated at the transmitter from components such as the line driver transistors, the line isolation transformer, and the DAC, and in the channel from various sources.

The compressor 110 of FIG. 1 is most suitably implemented on signals in the digital form, just before they pass through the DAC 115. This has the advantage of making the compression function very precise. It may also result in improved linearity and resolution for the DAC 115 due to reducing the amount of extra range needed to handle the highest peaks without clipping. The compression is achieved by a nonlinear (or possibly piecewise linear) compression function:

y=f(x),

in which x represents the amplitude of a signal being compressed and y represents the amplitude of the signal following compression. The compression function has the property that its slope f′(x) decreases (either continuously or in steps) as the magnitude of x increases in absolute value. It should also have the property that

f(−x)=−f(x)

The optimal choice of a particular compression function may depend on the details of the communication system in which it is applied, but is probably not highly critical, and a variety of choices may prove to be satisfactory. There are a number of possible choices for this function, including, without limitation, inverse tangent, inverse linear-plus-power, inverse sine, and mu law. Two of these choices have been evaluated experimentally: the inverse tangent function and an inverse linear-plus-cubic function. In both cases it is convenient to define a parameter xₕ as the value of x for which the slope of the compression function has decreased to 0.5 of its value at x=0. Then the inverse tangent embodiment of the compression function is expressed as:

y=xₕ arctan(x/xₕ).

The form of the corresponding decompression function is given by:

x=xₕ tan(y/xₕ).

In the inverse linear plus cubic embodiment, the decompression function is selected to have the simple form of a cubic equation; the general solution of a cubic equation, which is to be found in most mathematical handbooks, is used to obtain the compression function:

$$y = {x}_{h} \cdot ( 3 / 4 ) [ \sqrt[3]{2 ( x / {x}_{h} ) + \sqrt{1 + 4 {( x / {x}_{h} )}^{2}}} + \sqrt[3]{2 ( x / {x}_{h} ) - \sqrt{1 + 4 {( x / {x}_{h} )}^{2}}} ] .$$

Which corresponds to a decompression function of the desired linear-plus-cubic form:

x=y+βy³, where β=16/(27xₕ²)

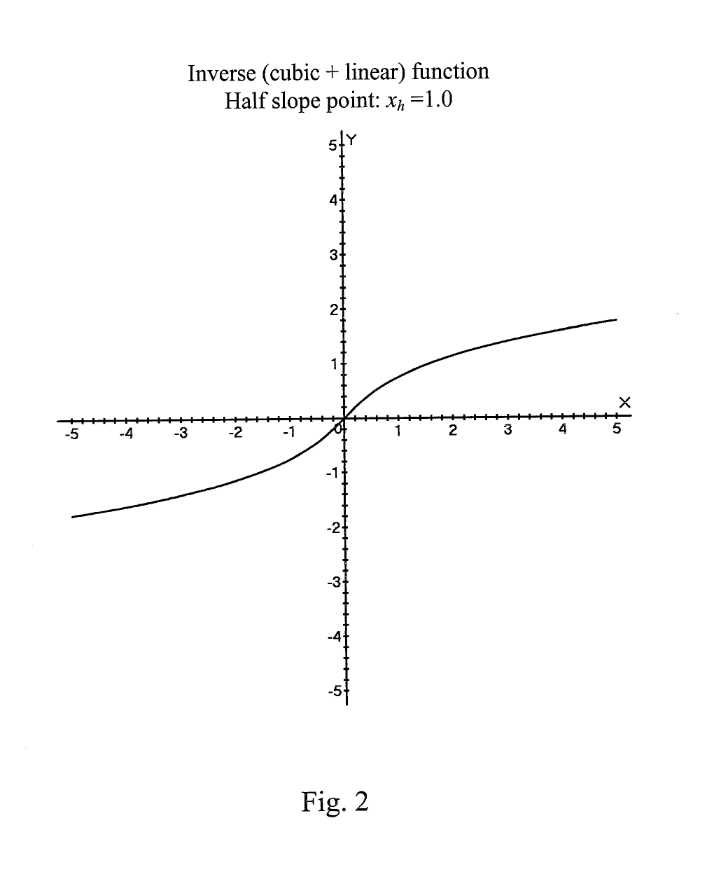

This case is graphed in FIG. 2. When done in the digital regime, it is straightforward to implement the compressor 110 using either of these choices. By properly selecting the parameter xₕ, a desired level of PAR reduction can be achieved. Selection of this parameter may require an iterative refinement process to obtain a value that gives a desired result. In this regard, for the particular signal to be compressed, the iterative refinement process would numerically determine the PAR for a given xₕ, and then readjust xₕ, repeating the calculation until the desired PAR value is reached. It is observed that compression according to these principles will tend to reduce the average power level of the signal by an amount that depends on the characteristics of the signal being compressed. Thus it may be desirable to multiply y(t) by a parameter selected to restore the average power level in the signal path to the desired level. For a DMT (discrete multitone) modulated signal, the PAR is about 14.5 dB for a clipping rate of 1 in 10⁷. This is considered by the official specifications for ADSL (asymmetric digital subscriber line) to be an acceptable clipping rate. It is anticipated that a reduction in PAR by at least 6 dB is achievable with relatively low impact on data recovery. This has the potential to cut power consumption in line driver transistors by about a factor of 2, or more.

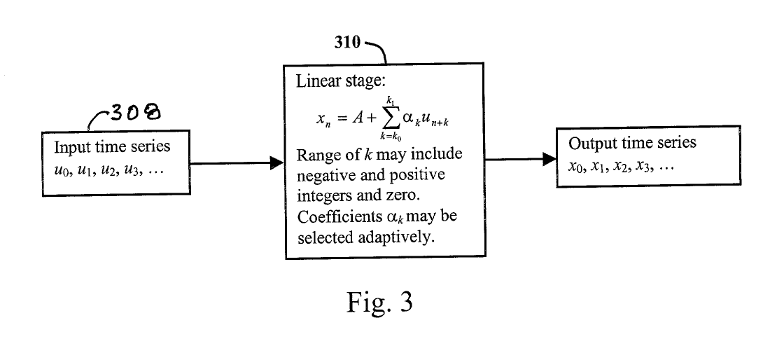

The multistage equalizer consists of at least two stages. Each stage takes one digital time series u₁, u₂, u₃, . . . as input and produces another one v₁, v₂, v₃, . . . as output. The stages are characterized by respective functions which may depend on a number of settable parameters. In the following, the stages are, in fact, described in terms of the functions that characterize them, with the understanding that the functions are entirely descriptive of the structures of the stages, as well as their operations. FIG. 3 shows an embodiment of a function that characterizes the structure and operation of the linear stage 140 of the multistage equalizer 137. The linear stage 140 is modeled as a finite-impulse response (FIR) filter characterized by the function:

$${v}_{n} = A + {\sum }_{k = {k}_{0}}^{{k}_{1}} {α}_{k} {u}_{n + k}$$

With reference to FIG. 1 and using the function 310 shown in FIG. 3 as the first stage 140 of the multistage equalizer 137, the output of the ADC 135 is received by the first stage 137 as a time sequence of digital values (the input time series 308). In the function 310, each successive digital value is associated with a factor, in this case, a coefficient aₖ, having a value that is combined (multiplied, in this case) with the digital value uₙ₊ₖ to yield a product. The range of the index k will typically include all integer values between chosen starting and ending values k₀ and k₁. Note that these values may be positive, negative, or zero. The values used will depend on the dispersion and other characteristics of a particular channel. If needed, a constant parameter A may be included as indicated to correct for shifts in the level of the signal.

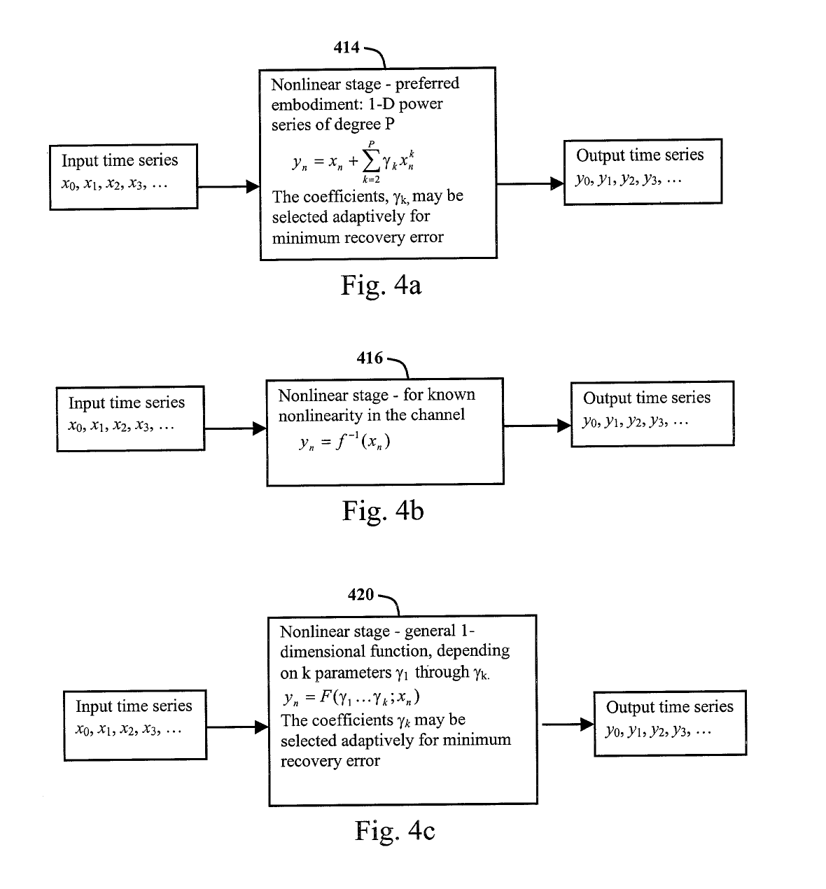

FIGS. 4a, 4b and 4c show three embodiments of decompression functions that characterize the operation and structure of the nonlinear stage 145 of the multistage equalizer 137. The power series function shown in FIG. 4a provides flexibility and the possibility of gaining some level of correction for intrinsic nonlinearities in the signal path in addition to achieving its primary function of decompressing the signal. This function has settable parameters that are processed as described earlier; it is given by:

$${v}_{n} = {u}_{n} + {\sum }_{k = 2}^{P} {γ}_{k} {u}_{n}^{k}$$

FIG. 4b illustrates the decompression function as simply the function that is the inverse of the compression function, two examples of which were given earlier. In FIG. 4c, the decompression function is represented as a generalized expansion (other than a power series).

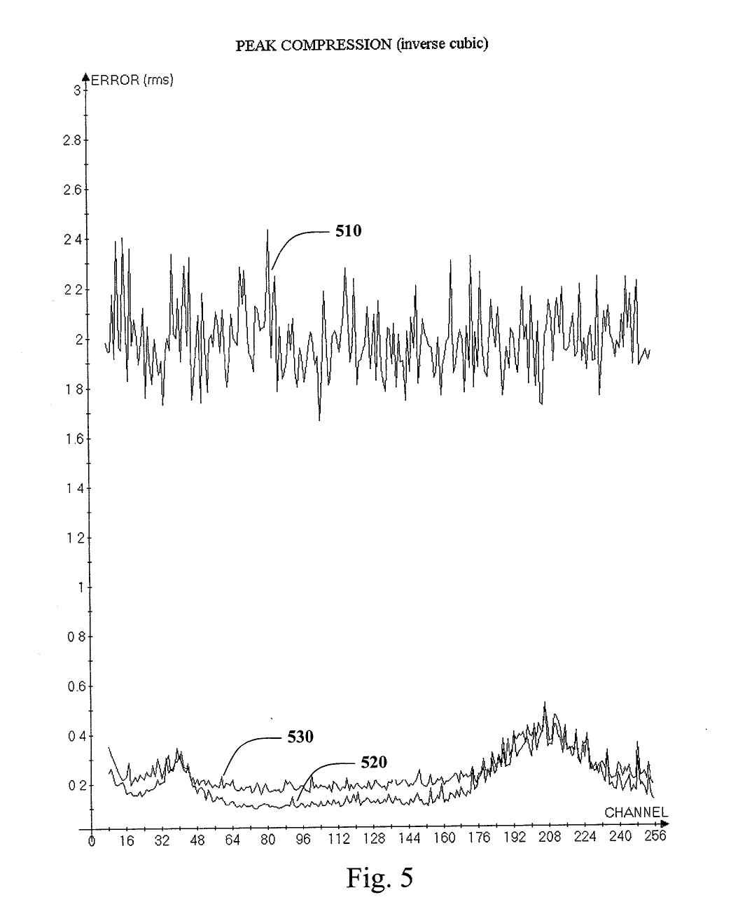

FIG. 5 is a graph showing experimental results for the case in which a compressor characterized by the inverse cubic function described above achieves about a 6-dB reduction in PAR. The upper curve 510 is the error measure as a function of channel for the compressed signal using only linear equalization to correct signal distortion. The bottom curve 520 is for an uncompressed signal also corrected only with linear equalization. The curve 530 represents the compressed signal processed correctly by a multistage equalizer having a first, linear stage characterized by the linear function illustrated in FIG. 3, and a second, nonlinear stage characterized by the nonlinear function illustrated in FIG. 4a.

The invention is claimed as follows:

1. In a digital transmission system, a combination for limiting the peak-to-average power ratio in a digitally-modulated signal transmitted in a dispersive medium, comprising:
a compressor characterized by a nonlinear function that receives a first digital representation of a digitally-modulated signal and produces a second digital representation of the digitally-modulated signal in which amplitude has been compressed;
a digital-to-analog converter (DAC) with an input coupled to receive the second digital representation and an output; and
a hybrid with an input coupled to the output of the DAC and an output for coupling an amplified, digitally-modulated analog signal for transmission in a dispersive channel.

2. The combination of claim 1, the nonlinear function being:
y=xₕ arctan(x/xₕ);
in which x is the uncompressed amplitude of a digitally modulated signal and xₕ is a value of x at which the slope of the compression function has decreased to 0.5 of its value at x=0.

3. The combination of claim 1, the nonlinear function being:
$$y = {x}_{h} \cdot ( 3 / 4 ) [ \sqrt[3]{2 ( x / {x}_{h} ) + \sqrt{1 + 4 {( x / {x}_{h} )}^{2}}} + \sqrt[3]{2 ( x / {x}_{h} ) - \sqrt{1 + 4 {( x / {x}_{h} )}^{2}}} ]$$
in which x is the uncompressed amplitude of a digitally modulated signal and xₕ is a value of x at which the slope of the compression function has decreased to 0.5 of its value at x=0.

4. The combination of claim 1, further including:
a dispersive medium coupled to the hybrid:
a receiver having an input coupled to the dispersive medium for receiving a digitally-modulated analog signal, and an output;
an analog-to-digital converter (ADC) coupled to the receiver output for providing a digital representation of a received digitally-modulated analog signal; and,
a multistage equalizer coupled to receive a digital representation of a received, digitally-modulated signal produced by the ADC and to correct the digital representation for linear distortion and compression of the digitally-modulated signal.

5. The combination of claim 4, the multistage equalizer including:
at least a first stage characterized by a first function to produce first results correcting linear distortion in the digital signal; and
at least a second stage coupled to the first stage, the second stage characterized by a second function to produce from the first results second results decompressing the digital signal.

6. The combination of claim 5, in which the second function is a decompression function which is the inverse of the nonlinear function.

7. The combination of claim 6, the nonlinear function being:
y=xₕ arctan(x/xₕ);
in which x is the uncompressed amplitude of a digitally modulated signal and xₕ is a value of x at which the slope of the compression function has decreased to 0.5 of its value at x=0; and,
the second function being:
x=xₕ tan(y/xₕ).

8. The combination of claim 6, the nonlinear function being:
$$y = {x}_{h} \cdot ( 3 / 4 ) [ \sqrt[3]{2 ( x / {x}_{h} ) + \sqrt{1 + 4 {( x / {x}_{h} )}^{2}}} + \sqrt[3]{2 ( x / {x}_{h} ) - \sqrt{1 + 4 {( x / {x}_{h} )}^{2}}} ]$$
in which x is the uncompressed amplitude of a digitally modulated signal and xₕ is a value of x at which the slope of the compression function has decreased to 0.5 of its value at x=0; and,
the second function being:
x=y+βy³;
where β=16/(27xₕ²).

9. The combination of claim 5, the second function being:
$${v}_{n} = {u}_{n} + {\sum }_{k = 2}^{P} {γ}_{k} {u}_{n}^{k}$$
where u₁, u₂, u₃, . . . is an input digital time series, and v₁, v₂, v₃, . . . is an output digital time series.

10. In a digital communication system in which digitally-modulated signals are compressed by a nonlinear function and transmitted in a dispersive medium, the combination including:
an analog-to-digital converter;
a line receiver for coupling a nonlinearly-compressed digitally-modulated analog signal from the dispersive medium to the converter; and
a multistage equalizer coupled to receive a digital signal produced by the converter in response to the analog signal and to correct the digital signal for linear distortion and for compression of the signal.

11. The combination of claim 10, the multistage equalizer including:
at least a first stage characterized by a first function to produce first results correcting linear distortion in the digital signal; and
at least a second stage coupled to the first stage, the second stage characterized by a second function to produce from the first results second results decompressing the digital signal.

12. The combination of claim 11, the nonlinear function being:
y=xₕ arctan(x/xₕ);
in which x is the uncompressed amplitude of a digitally modulated signal and xₕ is a value of x at which the slope of the function has decreased to 0.5 of its value at x=0.

13. The combination of claim 12, the second function being:
x=xₕ tan(y/xₕ).

14. The combination of claim 11, the nonlinear function being:
$$y = {x}_{h} \cdot ( 3 / 4 ) [ \sqrt[3]{2 ( x / {x}_{h} ) + \sqrt{1 + 4 {( x / {x}_{h} )}^{2}}} + \sqrt[3]{2 ( x / {x}_{h} ) - \sqrt{1 + 4 {( x / {x}_{h} )}^{2}}} ]$$
in which x is the uncompressed amplitude of a digitally modulated signal and xₕ is a value of x at which the slope of the function has decreased to 0.5 of its value at x=0.

15. The combination of claim 14, the second function being:
x=y+βy³;
where β=16/(27xₕ²).

16. A multistage equalizer for use in limiting peak-to-average power ratio in a digital communication system in which digitally-modulated signals are compressed by a nonlinear function and transmitted in a dispersive channel, comprising:
at least a first stage characterized by a first function to produce first results correcting linear distortion in a digital representation of a digitally-modulated signal received from a dispersive channel; and
at least a second stage coupled to the linear stage, the second stage characterized by a second function to produce from the first results second results decompressing the digital representation of the signal.

17. The multistage equalizer of claim 16, the nonlinear function being:
y=xₕ arctan(x/xₕ);
in which x is the uncompressed amplitude of a digitally modulated signal and xₕ is a value of x at which the slope of the function has decreased to 0.5 of its value at x=0.

18. The multistage equalizer of claim 17, the second function being:
x=xₕ tan(y/xₕ).

19. The multistage equalizer of claim 16, the nonlinear function being:
$$y = {x}_{h} \cdot ( 3 / 4 ) [ \sqrt[3]{2 ( x / {x}_{h} ) + \sqrt{1 + 4 {( x / {x}_{h} )}^{2}}} + \sqrt[3]{2 ( x / {x}_{h} ) - \sqrt{1 + 4 {( x / {x}_{h} )}^{2}}} ]$$
in which x is the uncompressed amplitude of a digitally modulated signal and xₕ is a value of x at which the slope of the function has decreased to 0.5 of its value at x=0.

20. The multistage equalizer of claim 19, the second function being:
x=y+βy³;
where β=16/(27xₕ²).
